(19) United States
(12) Patent Application Publication
(10) Pub. No.: US 2015/0206219 A1
(43) Pub. Date: Jul. 23, 2015

(54) SYSTEMS AND METHODS FOR PRICING ANALYSIS

(71) Applicant: Jharna Bhatt, (US)

(72) Inventors: Kamal Zamer, Austin, TX (US); Nikhil Vijay Thaker, Round Rock, TX (US)

(21) Appl. No.: 14/160,281

(22) Filed: Jan. 21, 2014

(51) Int. Cl. G06Q 30/06

(52) U.S. Cl. CPC G06Q 30/0629

(57) ABSTRACT

A system or a method is provided to collect pricing information from offline merchants at various geographical locations. The pricing information may include prices of various items offered at different offline merchants. The pricing information may be stored and analyzed to determine pricing trends at different time or locations. The pricing information may be presented to a user to provide pricing analysis to the user. Further, a merchant may publish pricing strategies or rules to the system. The pricing strategies may indicate that prices of certain items sold at the merchant may change over time based on certain conditions. Thus, pricing information from the offline merchants may be provided to users at appropriate times. In addition, a user may provide pricing information of items purchased by the user to the system. As such, pricing information from various offline merchants may be obtained by crowd sourcing.

### BACKGROUND

1. Field of the Invention

The present invention generally relates to systems and methods for pricing analysis.

2. Related Art

Consumers are increasingly making purchases online. In particular, there are online services that provide consumers with price comparison for a product or service offered at different merchants. Nevertheless, when consumers are shopping offline at brick-and-mortar stores, it becomes more difficult to compare prices among these offline brick-and-mortar stores. In particular, when a consumer visits a new place, it is difficult for the consumer to determine whether a price of an item sold at a brick-and-mortar store is a fair or competitive price. For example, when the consumer is looking for a Banana boat ride in Daytona Beach, Fla., a buffet in Las Vegas, or shopping in a flea market in Shanghai or in Fashion Street in Mumbai, the consumer may not be able to compare prices among different merchants without physically visiting all of them, which is inconvenient and time consuming. Therefore, there is a need for a system or method that provides pricing analysis for offline merchants.

### BRIEF DESCRIPTION OF THE FIGURES

FIG. 1 is a block diagram of a networked system suitable for performing pricing analysis according to an embodiment.

FIG. 2A is a flowchart showing a process of receiving pricing information from merchants according to one embodiment.

FIG. 2B is a flowchart showing a process of receiving pricing information from users according to one embodiment.

FIG. 3 is a flowchart showing a process for pricing analysis according to one embodiment.

FIG. 4 is a block diagram of a computer system suitable for implementing one or more components in FIG. 1 according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to an embodiment, a system or a method is provided to collect pricing information from merchants at various geographical locations. The pricing information may include prices of various items offered at different merchants. The pricing information may be stored and analyzed to determine pricing trends at different times or locations. The pricing information may be presented to a user to provide pricing analysis to the user so that the user can make a more informed purchasing decision.

In one embodiment, a merchant may publish pricing strategies to the system. The pricing strategies may indicate that prices of certain items sold at the merchant may change over time based on certain conditions. For example, the price of a shirt may decrease by the end of a business day if the inventory of the shirt is above a certain amount. In one embodiment, a user may provide pricing information of items purchased by the user to the system. As such, pricing information at various merchants may be obtained by crowd sourcing. The pricing information may be stored and analyzed to provide pricing analysis to consumers.

Further, the system may monitor a user's location and purchase history to determine the user's shopping preference. For example, the system may monitor a user's travel schedule, calendar, browsing history, or the like to determine a potential purchase target which the user may desire to purchase. Based on the user's location or travel schedule, the system may present to the user a pricing analysis for the purchase target from various merchants located near the user. Thus, the user may be informed of a fair price for the purchase target and the merchants that offer the purchase target for sale.

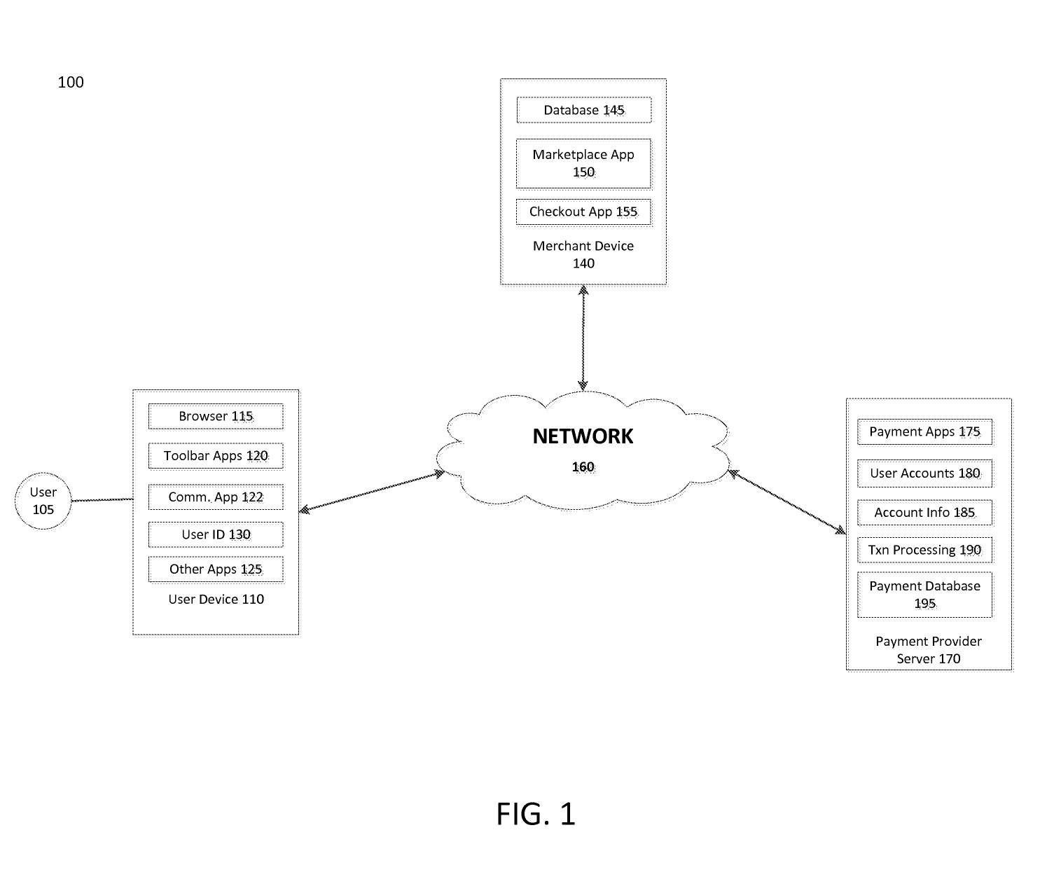

FIG. 1 is a block diagram of a networked system 100 suitable for implementing a process for facilitating purchases using peripheral devices according to an embodiment. Networked system 100 may comprise or implement a plurality of servers and/or software components that operate to perform various payment transactions or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include a user device 110, a merchant server 140, and a payment provider server 170 in communication over a network 160. Payment provider server 170 may be maintained by a payment service provider, such as PayPal, Inc. of San Jose, Calif. A user 105, such as a sender or consumer, utilizes user device 110 to perform a transaction using payment provider server 170. User 105 may utilize user device 110 to initiate a payment transaction, receive a transaction approval request, or reply to the request. Note that transaction, as used herein, refers to any suitable action performed using the user device, including payments, transfer of information, display of information, etc. For example, user 105 may utilize user device 110 to initiate a deposit into a savings account. Although only one merchant server is shown, a plurality of merchant servers may be utilized if the user is purchasing products or services from multiple merchants.

User device 110, merchant server 140, and payment provider server 170 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, user device 110 may be implemented as a personal computer (PC), a smart phone, personal digital assistant (PDA), laptop computer, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for setting up a shopping list and/or merchant sites for viewing and purchasing products and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 may further include other applications 125 as may be desired in particular embodiments to provide desired features to user device 110. For example, other applications 125 may include security applications for implementing client-side security features, programmatic client applications for interfacing with appropriate application programming interfaces (APIs) over network 160, or other types of applications.

Applications 125 may also include email, texting, voice and IM applications that allow user 105 to send and receive emails, calls, and texts through network 160, as well as applications that enable the user to communicate, transfer information, make payments, and otherwise utilize a smart wallet through the payment provider as discussed above. User device 110 includes one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100.

Merchant server 140 may be maintained, for example, by a merchant or seller offering various products and/or services. The merchant may have a physical point-of-sale (POS) store front. The merchant may be a participating merchant who has a merchant account with the payment service provider. Merchant server 140 may be used for POS or online purchases and transactions. Generally, merchant server 140 may be maintained by anyone or any entity that receives money, which includes charities as well as banks and retailers. For example, a payment may be a donation to charity or a deposit to a saving account. Merchant server 140 may include a database 145 identifying available products (including digital goods) and/or services (e.g., collectively referred to as items) which may be made available for viewing and purchase by user 105. Accordingly, merchant server 140 also may include a marketplace application 150 which may be configured to serve information over network 160 to browser 115 of user device 110. In one embodiment, user 105 may interact with marketplace application 150 through browser applications over network 160 in order to view various products, food items, or services identified in database 145.

Merchant server 140 also may include a checkout application 155 which may be configured to facilitate the purchase by user 105 of goods or services online or at a physical POS or store front. Checkout application 155 may be configured to accept payment information from or on behalf of user 105 through payment service provider server 170 over network 160. For example, checkout application 155 may receive and process a payment confirmation from payment service provider server 170, as well as transmit transaction information to the payment provider and receive information from the payment provider (e.g., a transaction ID). Checkout application 155 may be configured to receive payment via a plurality of payment methods including cash, credit cards, debit cards, checks, money orders, or the like.

Merchant server 140 may store pricing information for various goods or services offered by the merchant. Merchant server 140 may communicate the pricing information including pricing rules or strategies to payment provider server 170. In some embodiments, user device 110 may communicate the pricing information of items purchased by user 105 to payment provider server 170. The pricing information may include price offered at the merchant, time, and location of the merchant.

Payment provider server 170 may be maintained, for example, by an online payment service provider which may provide payment between user 105 and the operator of merchant server 140. In this regard, payment provider server 170 includes one or more payment applications 175 which may be configured to interact with user device 110 and/or merchant server 140 over network 160 to facilitate the purchase of goods or services, communicate/display information, and send payments by user 105 of user device 110.

Payment provider server 170 also maintains a plurality of user accounts 180, each of which may include account information 185 associated with consumers, merchants, and funding sources, such as banks or credit card companies. For example, account information 185 may include private financial information of users of devices such as account numbers, passwords, device identifiers, user names, phone numbers, credit card information, bank information, or other financial information which may be used to facilitate online transactions by user 105. Advantageously, payment application 175 may be configured to interact with merchant server 140 on behalf of user 105 during a transaction with checkout application 155 to track and manage purchases made by users and which and when funding sources are used.

In some embodiments, payment provider server 170 may maintain a pricing information database including pricing information for various items offered at various merchant across various geographical locations. Payment provider server 170 may analyze the pricing information to determine pricing trends over time for various items. Pricing for certain items also may be predicted at a future time based on the pricing information. The pricing information may be organized by merchant, item, price, time, or location. Payment provider server 170 may continuously update the pricing information database.

A transaction processing application 190, which may be part of payment application 175 or separate, may be configured to receive information from user device 110 and/or merchant server 140 for processing and storage in a payment database 195. Transaction processing application 190 may include one or more applications to process information from user 105 for processing an order and payment using various selected funding instruments, including for initial purchase and payment after purchase as described herein. As such, transaction processing application 190 may store details of an order from individual users, including funding source used, credit options available, etc. Payment application 175 may be further configured to determine the existence of and to manage accounts for user 105, as well as create new accounts if necessary.

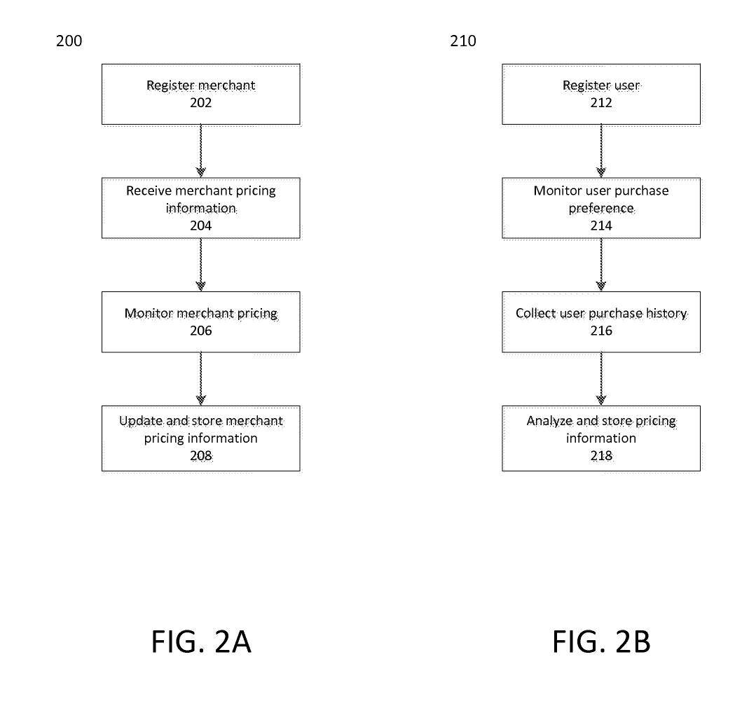

FIG. 2A is a flowchart showing a process 200 for receiving pricing information from merchants according to one embodiment according to one embodiment. The merchants may be offline merchants that offer products or services for sale in brick-and-mortar stores. Some of these offline merchants may not have virtual online stores that offer products or services for sale via internet commerce. Thus, it may be difficult for consumers to obtain pricing information from these offline merchants via the internet.

At step 202, a merchant may register with payment provider server 170. For example, the merchant may become a participating merchant by registering with payment provider server 170. Merchant information, such as the merchant's name, location, merchant type, product or service offered, may be provided to payment provider server 170. A merchant account may be created for the merchant after registration. The merchant account may be a financial account for sending or receiving funds.

At step 204, payment provider server 170 may receive pricing information from the merchant. For example, a user interface may be provided at a website of payment provider server 170 to receive pricing information from the merchant. The merchant may upload pricing information to payment provider server 170. In some embodiments, the merchant may grant access to payment provider server 170 to pull pricing information from merchant device 140. The pricing information may include name or identification of products or services offered at the merchant and their prices. The pricing information may be formatted in a spreadsheet and sent to payment provider server 170 via network 160.

The pricing information may include pricing strategies or rules of the merchant. Prices for certain items may be determined by certain rules or conditions. For example, price of gas at a gas station may vary based on the number of sales or the amount of gas in reserve at the gas station. Price of gas may increase when demand increases or when the gas reserve is depleted. In another example, the price for fresh fish may decrease (once or several times) later in the day to provide a high likelihood that all fish is sold before the day ends. Thus, payment provider server 170 may provide an interface for the merchant to set up different pricing strategies or rules for various items offered at the merchant.

The merchant may set up pricing strategy to change price over time, such as over a day or a year. Different time of the day or different season of the year may cause prices certain items to vary accordingly. The merchant may set up pricing strategy to change price based on inventory flow. For example, the merchant may offer discounts for items that need to be cleared from inventory. The merchant also may offer discounts on items that have excess inventory. An item that has higher demand may have higher price when inventory is low for that item.

At step 206, payment provider server 170 may monitor prices of various items. For example, based on the pricing strategies or pricing updates received from merchants, payment provider server 170 may track prices of various items over time. A pricing history or trend then may be determined for various items.

At step 208, payment provider server 170 may continuously update and store the pricing information from various merchants. The pricing information may be updated periodically. Based on the type of products or services, the pricing information may be updated at different frequencies. Prices that fluctuate more frequently may be updated more frequently. For example, price of gas may be updated daily while price of books may be updated monthly. Thus, different products or services may have different update frequencies.

By using the above process 200, pricing information may be received from offline merchants. For example, payment provider server 170 may provide an interface to receive price data or pricing strategies or rules from the offline merchants. Further, prices of various items may be tracked and monitored over time to determine price trends for these items. The pricing data may be stored and organized for future reference or pricing analysis.

FIG. 2B is a flowchart showing a process 210 for receiving pricing information from users according to one embodiment. At step 212, a user may register at payment provider server 170. For example, a user may set up a payment account at payment provider server 170 using user device 140. The payment account may be used for making payments for purchases made by the user. The payment account may include user information, such as user identification, password, user preferences, funding accounts, and the like.

At step 214, payment provider server 170 may monitor user purchase preferences. For example, when user 105 uses user device 140 to search or browse various products or services, payment provider server 170 may determine a potential purchase target based on user 105's browsing or search history. For example, user 105 may have been searching or browsing various types of laptops using user device 140, the browsing and searching history related to the various types of laptops may be sent to payment provider server 170.

In one embodiment, user 105 may give permission to payment provider server 170 to access the browsing or search history at user device 140. Payment provider server 170 may analyze the browsing history and search history and determine that user 105 is looking to purchase a laptop. In particular, payment provider server 170 may determine the type of laptop user 105 is looking for. Thus, the type of the laptop may be designated as a purchase target. User 105's purchase history also may be used to determine user's purchase preference. For example, the type of products or services that had been purchased by user 105, the merchants from which user 105 had made purchases, or the time and location where user 105 make purchases may be monitored and stored as user purchase preference.

At step 216, payment provider server 170 may collect user purchase history. For example, when user 105 uses user device 140 to make a purchase, payment provider server 170 may collect information related to the purchase, including the identity and type of items purchased, price of the item purchased, location and time of purchase, merchant from whom the purchase was made, or other information related to the purchase.

At step 218, payment provider server 170 may analyze and store pricing information obtained from user device 140. For example, prices of items collected from various users may be aggregated into a pricing database. Thus, a database of pricing information may be generated by crowd sourcing. Further, payment provider server 170 may analyze prices of various items from various merchants to determine pricing trends over time. Pricing comparison among different merchants also may be conducted to find best prices. Further, price changes over time may be monitored to determine a pricing trend to identify a best time (during the day, during the week, during the month, during the year, etc.) to make a purchase.

By using the above process 210, pricing information may be collected from a user. Further, a pricing information database may be created by crowd sourcing price information from various users. Further, user's purchase preference also may be collected from user's search history or browsing history.

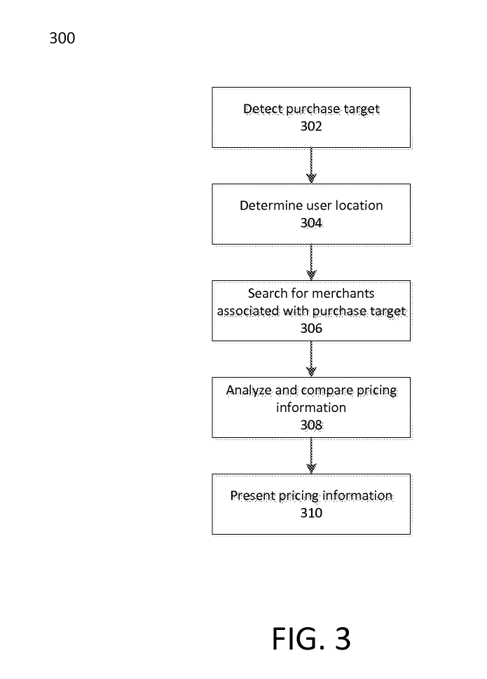

FIG. 3 is a flowchart showing a process for pricing analysis according to one embodiment. At step 302, payment provider server 170 may detect a purchase target. In particular, payment provider server 170 may detect that user 105 is searching or browsing for certain products or services based on user 105's browsing history or search history at user device 110. For example, user 105 may use a search engine or a shopping application on user device 110 to search and browse for women's watches offered at different merchants or websites. Thus, payment provider server 170 may determine that user 105 may be interested in purchasing a women's watch. In particular, payment provider server 170 may determine the type, model, style, and/or price range of women's watches user 105 may be interested in. Thus, payment provider server 170 may determine that a certain type or style of women's watch as the purchase target. In one embodiment, user 105 may designate the purchase target and request that payment provider server 170 to provide pricing information and pricing analysis for the designated purchase target. For example, user 105 may subscribe to be alerted for price discounts for women's watches near user 105's location.

At step 304, payment provider server 170 may determine the location of user 105. User device 110 may include a Global Positioning System (GPS) device configured to detect a location of user device 110. The position of user device 110 may be sent to payment provider server 170. Thus, payment provider server 170 may determine a location of user 105 based on the location of user device 110. Other methods of locating user 105 also may be utilized. For example, a location of a wired or wireless network at which user device 110 is connected may be used to locate user 105 or the user may enter a desired location.

In one embodiment, payment provider server 170 may determine an anticipated location of user 105 based on user 105's travel schedule or calendar. For example, payment provider server 170 may access user 105's calendar or travel schedule at user device 110. Payment provider server 170 may analyze user 105's calendar or travel schedule to determine a current location of user 105. In one embodiment, payment provider server 170 may predict a future location of user 105 based on user 105's anticipated travel schedule or appointments on the calendar. For example, user 105 may have a meeting scheduled in the calendar for tomorrow at the city center and payment provider server 170 may predict or infer that user 105 may be located at the city center tomorrow for the meeting.

At step 306, payment provider server 170 may search for merchants that offer the purchase target for sale. In particular, payment provider server 170 may access the pricing database which stores pricing information for various items at various offline merchants. Payment provider server 170 may query the pricing database for offline merchants that offer products or services similar to the purchase target. Merchants that offer the same type or style of products similar to that of the purchase target may be searched for. In particular, offline merchants that are located near the user's location may be queried. In some embodiments, the merchants may be found by searching for products or services offered at the merchants. For example, payment provider server 170 may search for products or services similar to the purchase target in the pricing database. When the products or services similar to the purchase target are found, the merchants that offer these products or services for sale may be identified.

At step 308, payment provider server 170 may analyze the prices of the products or services offered at the various merchants. The analysis may include current price comparison which compares the current prices offered at various merchants near user 105. The analysis also may include pricing trends of the products or services from various merchants. Thus, user 105 may be presented with a best time to purchase the products or services to obtain the best price. Customer reviews and ratings for the merchants also may be presented to user 105 to make appropriate decisions on purchase.

In some embodiments, prices offered at merchants located near an anticipated location of user 105 also may be searched for and presented to user 105. For example, payment provider server 170 may access user 105's calendar at user device 110 and determine that user 105 will be in the city center for a meeting tomorrow. Payment provider server 170 may search for merchants near the city center that offer products or services similar to the purchase target for sale. In particular, the prices of the products or services offered at these city center merchants may be considered for pricing analysis. Tomorrow's anticipated prices from these city center merchants may be used for pricing analysis. Tomorrow's anticipated price may be determined based on pricing strategies or pricing rules set up by these merchants. In some embodiments, tomorrow's anticipated price may be determined based on historical pricing trends from these merchants. The anticipated price may include a probability. For example, 85% probability that the price will be $10. Thus, a user may make appropriate decision based on the information provided to the user.

Pricing analysis may compare price among different merchants near a current location of user 105 and other anticipated locations of user 105. Further, current prices and future anticipated prices also may be compared to determine a best time to make a purchase. Thus, the pricing analysis may compare price across merchants, locations, and time to present a comprehensive analysis to user 105.

For prices that are determined by a merchant's pricing strategies or rules, a current price may be determined by whether certain conditions are satisfied. For example, a current price may be dependent on inventory volume or sales volume. With the merchant's permission, payment provider server 170 may access the inventory or sales information at merchant device 140 to determine the current price accordingly. Further, based on current conditions and historical data, payment provider server 170 may infer or predict the price at a future time. For example, a current price of a t-shirt at a beach town may be $10. However, based on the merchant's pricing rule, the price is reduced to $8 after 4:00 PM if the sales volume is below five (5) t-shirts. Because it is winter season and based on the sales trend of the merchant in the winter season, it is very unlikely that the merchant will sell five t-shirts by 4:00 PM. Thus, payment provider server 170 may predict that the price of the t-shirt will be $8 after 4:00 PM, based on the merchant's pricing rule and the sales trend of the merchant in the winter season.

The prediction may be calculated by probability. Payment provider server 170 may calculate, based on historical trends, that the probability of a discount at the merchant. For example, to predict prices for a Saturday in a summer season, payment provider server 170 may consider historical pricing data of past Saturdays in summer seasons and may consider the percentage of summer Saturdays that have discount prices. The percentage may be used as a probability for predicting whether there will be a discount for this Saturday. Therefore, by considering pricing trends over time and location together with merchant's pricing strategies or rules, payment provider server 170 may make comprehensive predictions of prices.

Further, an average price for the purchase target may be calculated by averaging prices from various merchants near a location. In some embodiments, prices from different merchants may be weighted differently for calculating the average price. For example, prices from merchants located closer to user 105's location may be weighted more than prices from merchants located farther from user 105's location. In another example, recently updated prices may be weighted more than older prices. Thus, a more accurate average price may be calculated based on time and location.

At step 310, payment provider server 170 may present the results of pricing analysis to user 105 at user device 110. The pricing analysis may be presented in various forms, such as pie charts, line graphs, price v. location mapping, bar charts, and the like. For example, a time v. average price for a certain location may be plotted to show user 105 the change of price over time for merchants located near the location. In another example, a map of various merchants in the area may be presented with prices and/or customer reviews listed next to the mapped merchants. Thus, user 105 may visualize the locations of different merchants along with their prices and/or customer reviews.

In some embodiments, payment provider sever 170 may monitor prices of certain items near user 105's location. Thus, notifications, such as price alerts, may be sent to user 105 to notify user 105 of price update at a nearby merchants. In particular, prices that are reduced significantly below the average prices may be notified to user 105. For example, payment provider server 170 may monitor prices of t-shirts in a location. When a merchant offers a deep discount on t-shirts, a price alert may be generated and sent to user 105 to notify user 105 of the new discounted price and the location of the merchant. Price predictions may be presented in terms of probability. For example, merchant A may have a 75% probability of having the best price and Merchant B may have a 20% probability of having the best price, and etc. In another example, there could be a 90% probability that the price is $8 at merchant A. Thus, probability may be used to provide precise information to user for user to make informed choices.

By using the above processes 200, 210, and 300, pricing information may be collected from merchants, users, or both. User purchase preferences also may be monitored and collected. The pricing infounation may be analyzed to present relevant pricing information to user for merchants near user's location. Further, pricing trends may be used to infer or predict future prices. Thus, pricing analysis may be implemented for off-line merchants to provide user with comprehensive pricing information for a new location visited by the user.

The following are exemplary scenarios in which the above processes 200, 210, and 300 may be implemented.

### Example 1

Nikhil has a store that sells dress shirts and is located on Fashion Street in Mumbai. Nikhil's store is called “Nikhil's Thrills.” Nikhil's Thrills accepts PayPal as a form of payment from customers at a POS terminal. Before Nikhil goes to work at the store, Nikhil uses his home computer to log into Nikhil's merchant account at PayPal's payment provider server.

PayPal merchant account interface allows Nikhil to set pricing strategies or rules for the dress shirts sold at his store. Thus, Nikhil specifies a pricing strategy on his PayPal merchant account as the following: “if less than 20 shirts are sold by 5:00 PM, reduce the price of shirts by 50% until the end of business.” Nikhil also selects to publish the prices of items sold at his store. For example, a red dress shirt for $50 may be the non-discounted price offered at his store. Customers or users of PayPal who subscribe to pricing updates would initially see that a red dress shirt is $50 at Nikhil's Thrills.

The pricing rule crated by Nikhil effectively initiated a possible discount at his store starting a 5:00 PM if certain sales conditions are not met. PayPal's server may analyze this pricing rule and determine that a potential sale may occur at 5:00 PM at Nikhil's Thrills. PayPal's server may notify users or customers located around the area of “Fashion Street” in Mumbai regarding the shirt sale at Nikhil's Thrills when less than 20 shirts are sold by 5:00 PM at Nikhil's Thrills.

Kamal is a tourist visiting Mumbai for the first time and wants to do some shopping around 5:00 PM. It is currently 4:00 PM. The concierge at the hotel recommends that Kamal visits Fashion Street. Kamal performs a search on his phone to locate Fashion Street. The PayPal app installed on his phone may recognize the “Fashion Street, Mumbai” search and present relevant pricing information around Fashion Street based on his searches and based on time. The PayPal service may access historical pricing information and determine if there are sales occurring or about to occur. In particular, the PayPal app may display merchants in the Fashion Street pricing zone, along with their probability of a sale. For example, the PayPal app may display to Kamal: “Nikhil's Thrills—20% probability of a sale after 5:00 PM—Fashion Street. Red dress shirts currently $50.”

Kamal selects to subscribe to pricing updates for Fashion Street area merchants, including Nikhil's Thrills. Kamal then goes to get some coffee in the hotel. When 5:00 PM approaches, Nikhil's Thrills still hasn't met the sales quota of 20 for the day. As a result, a 50% off sale is triggered at Nikhil's Thrills. Users who subscribe to “Fashion Street updates” or “Nikhil's Thrills Updates” are alerted on their PayPal app about the discount at Nikhil's Thrills. Kamal, who is still drinking coffee at 5:00 PM, receives this alert on his PayPal app about a significant discount at Nikhil's Trills on Fashion Street. “Red dress shirts are now $25, down from $50. Good from 5:00 PM till close”

Kamal goes to visit Nikhil's Thrills and purchases some dress shirts. Thus, Kamal is able to receive discounts based on PayPal's price updates. Further, Nikhil's Thrills increases sales volume by publishing prices using PayPal's merchant account to reach more customers. Both the users and the merchant are benefited even in the off-line environment.

### Example 2

Nikhil is vacationing with his family and decides to take a Banana Boat ride from “Bobby's Banana Boats.” Nikhil pays with PayPal and the purchase information is uploaded to the PayPal server through a PayPal app on his phone. In another embodiment, the PayPal POS terminal at the Banana Boat merchant may harness the purchase information.

A few weeks later, Kamal is visiting the same beach and is at his hotel near the beach. Kamal is looking to take a Banana Boat ride. There are many Banana Boat merchants near the beach and it may be difficult for Kamal to compare prices of Banana Boat rides offered at these merchants without physically visiting all of them. Thus, Kamal uses the PayPal app on his phone to perform price comparison. On the PayPal app, Kamal looks for “Banana Boat rides” near his location. In particular, Kamal selects price analysis in the payment zone which encompasses “Bobby's Banana Boats.”

PayPal's system may reference historical price information collected from prior purchases made by other consumers, including Nikhil's purchase information from a few weeks ago, to perform price analysis and comparison. Thus, PayPal's system may provide Kamal with the projected price for a Banana Boat ride from Bobby's Banana Boats. PayPal's analysis may include prices from other Banana boat merchants in the area. As such, PayPal may determine a probability of how much Kamal will pay at Bobby's Banana Boats and whether that is a good price, as compared with other merchants (also given as a probability).

PayPal's system may determine that Bobby's Banana Boats has historically low prices in the area and customers typically pay $10 for a ride on Thursday evenings 75% of the time. Since it's Thursday evening and Kamal is in an area near Bobby's Banana Boats, the PayPal system may determine that Bobby's Banana Boats is 99% likely to have the lowest price and a 75% chance Kamal will pay $10 for a ride. Thus, by leveraging the comprehensive pricing analysis from PayPal, Kamal is able to make informed choices when making a purchase. In this case, Kamal is able to find the best price from among these off-line banana boat merchants.

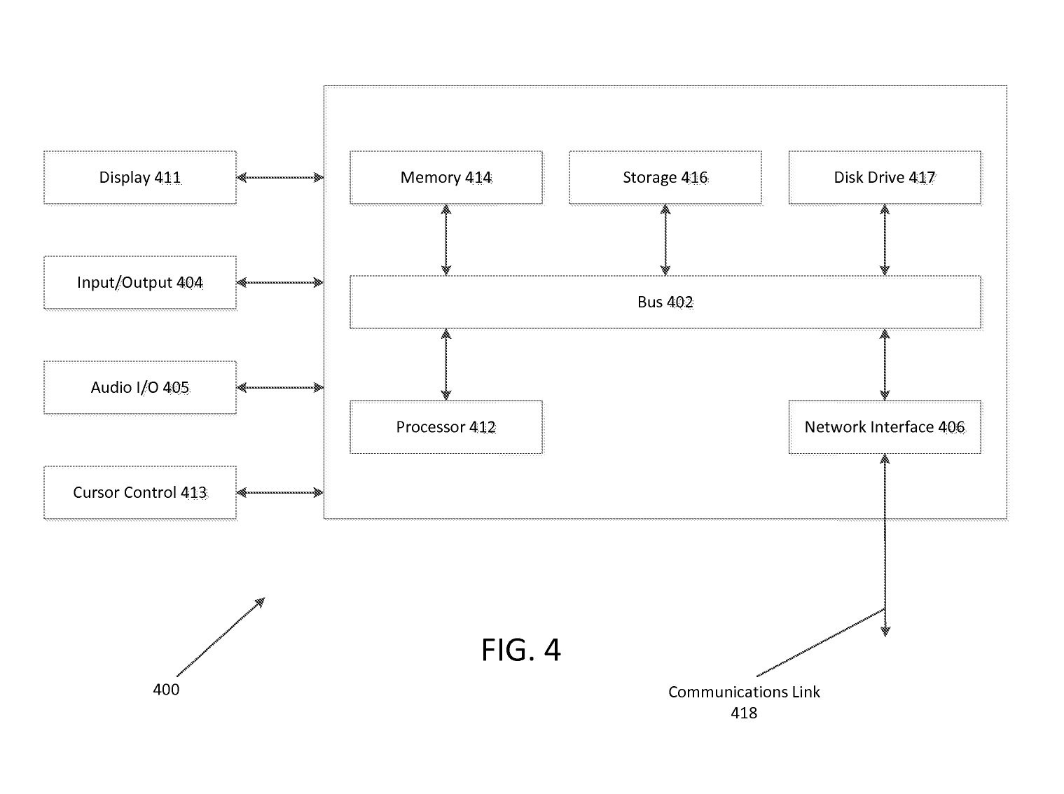

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 160. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a hardware memory storing information about a payment account of a user and a pricing information database comprising pricing information of products and services offered at merchants; and
one or more processors in communication with the memory and adapted to:
determine a purchase target indicating a product or service to be purchased by the user;
receive a location of the user;
search the pricing information database for offline merchants near the location of the user who offer the purchase target for sale;
perform pricing analysis on prices of the purchase target offered at the offline merchants; and
present results of the pricing analysis to the user.

2. The system of claim 1, wherein the one or more processors are further adapted to:
receive a payment request for making a purchase using the payment account;
receive purchase information related to the purchase including pricing information; and
storing the pricing information of the purchase in the pricing information database.

3. The system of claim 1, wherein the one or more processors are further adapted to:
receive pricing information from an offline merchant including prices of products or services offered at the offline merchant; and
storing the pricing information from the offline merchant.

4. The system of claim 3, wherein the pricing information received from the offline merchant includes pricing rules set by the offline merchant.

5. The system of claim 4, wherein the pricing rules include conditions based on sales volume or inventory volume.

6. The system of claim 1, wherein the purchase target is determined based on the user's browsing or search history.

7. The system of claim 1, wherein the location of the user is an anticipated location of the user determined based on the user's travel schedule or calendar events.

8. The system of claim 1, wherein the pricing analysis comprises comparing prices of the purchase target offered at the offline merchants near the user.

9. The system of claim 1, wherein the pricing analysis comprises predicting an anticipated price of the purchase target offered at an offline merchant based on historical pricing information.

10. The system of claim 1, wherein the pricing analysis comprises predicting an anticipated price of the purchase target offered at an offline merchant based on pricing rules set by the offline merchant and probability of conditions included in the pricing rules occurring.

11. The system of claim 1, wherein the one or more processors are further adapted to:
receive the user's subscription for price update for the purchase target;
monitor the prices of the purchase target offered at the offline merchants near the user; and
notify the user when a price discount is detected.

12. A method comprising:
determining, by a processor of a payment service provider, a purchase target indicating a product or service to be purchased by a user registered at the payment service;
receiving, by the processor, a location of the user;
searching, by the processor, in a pricing information database for offline merchants near the location of the user who offer the purchase target for sale;
performing, by the processor, pricing analysis on prices of the purchase target offered at the offline merchants; and
presenting, by the processor, results of the pricing analysis to the user.

13. The method of claim 12 further comprising:
receiving a payment request for making a purchase using the payment account;
receiving purchase information related to the purchase including pricing information; and
storing the pricing information of the purchase in the pricing information database.

14. The method of claim 12 further comprising:
receiving pricing information from an offline merchant including prices of products or services offered at the offline merchant; and
storing the pricing information from the offline merchant.

15. The method of claim 14, wherein the pricing information received from the offline merchant includes pricing rules set by the offline merchant.

16. The method of claim 15, wherein the pricing rules include conditions based on sales volume or inventory volume.

17. The method of claim 12, wherein the purchase target is determined based on the user's browsing or search history.

18. The method of claim 12, wherein the location of the user is an anticipated location of the user determined based on the user's travel schedule or calendar events.

19. The method of claim 12, wherein the pricing analysis comprises comparing prices of the purchase target offered at the offline merchants near the user.

20. The method of claim 12, wherein the pricing analysis comprises predicting an anticipated price of the purchase target offered at an offline merchant based on historical pricing information.

21. The method of claim 12, wherein the pricing analysis comprises predicting an anticipated price of the purchase target offered at an offline merchant based on pricing rules set by the offline merchant and probability of conditions included in the pricing rules occurring.

22. The method of claim 12 further comprising:
receiving the user's subscription for price update for the purchase target;
monitoring the prices of the purchase target offered at the offline merchants near the user; and
notifying the user when a price discount is detected.
